(19) United States
(12) Patent Application Publication
(10) Pub. No.: US 2018/0273410 A1
(43) Pub. Date: Sep. 27, 2018

(54) SYSTEM AND METHOD FOR WATER TREATMENT

(71) Applicant: Gopher Resource, LLC, Eagan, MN (US)

(72) Inventors: Joseph Grogan, Minneapolis (IE); Benjamin Rodrigue, Minneapolis, MN (US); James Dahlstrom, Bloomington, MN (US); Mike Fallon, Inver Grove Heights, MN (US)

(21) Appl. No.: 15/468,632

(22) Filed: Mar. 24, 2017

(51) Int. Cl. C02F 9/00

(52) U.S. Cl. CPC C02F 9/00; C02F 2101/106

(57) ABSTRACT

A method for removing selenium from an aqueous stream comprises adjusting the pH of the aqueous stream to an acidic pH and mixing a galvanic reductant into the aqueous stream to form a first process stream, the aqueous stream having a first selenium level; separating at least a majority of the galvanic reductant from the first process stream after a retention time to form a recovered galvanic reductant stream and a second process stream; adjusting pH of the second process stream to pH 9 or higher to form a third process stream comprising precipitated particles; separating the precipitated particles from the third process stream to form a sludge stream and a treated aqueous stream having a second selenium level, the second selenium level being less than 10% of the first selenium level.

### FIELD

The present disclosure relates to systems and methods for removing selenium and other contaminants from water. In particular, the present disclosure relates to systems and methods for removing selenate from water with a high sulfate content.

### BACKGROUND

Effluent streams from industrial processes may be contaminated with various metals and non-metals, including selenium, arsenic, lead, antimony, cadmium, chromium, etc. Selenium appears in various oxidation states, including Se⁰, Se⁻², Se⁺⁴ and Se⁺⁶, which form elemental selenium, selenides (H₂Se, HSe⁻), selenites (H₂SeO₃, HSeO₃¹⁻, SeO₃²⁻), and selenates (HSeO₄¹⁻, SeO₄²⁻). While elemental selenium is relatively non-toxic and is an important micronutrient to mammals, some forms of selenium (including selenites and selenates) may have a negative environmental impact. Thus, the amount of selenium in certain effluents, such as wastewater is regulated, and removal of selenium in the effluent stream before discharge is desired.

Methods for reducing the levels of selenium and heavy metals in aqueous media are known. For example, selenium can be removed by ferric ion co-precipitation, ion exchange, reverse osmosis, or filtration, depending on the form of selenium. However, the known technologies are either ineffective or uneconomical for removing all forms of selenium, and in particular selenate, from high sulfate wastewater. Selenium removal is difficult because some forms of selenium (e.g., selenate and selenite) are very soluble in water, and insoluble compounds are not easily formed. Sulfates further interfere with the removal of selenium due to the similarities in selenium and sulfur aqueous chemistries.

McCloskey et al. (McCloskey et al. Removal of Selenium Oxyanions from Industrial Scrubber Waters Utilizing Elemental Iron, in Proc. Sixth Int'l Symp. Hydrometallurgy 140-148 (2008)) have reported methods for removal of selenate from wastewater that are based on iron cementation. However, the methods described by McCloskey were only able to reduce selenate levels to about 0.35 ppm after 120 minutes of residence time in open vessel tests without control of the reaction atmosphere and temperature. Shorter residence times (e.g., 60 minutes) resulted in an unsatisfactory removal of selenate from the starting level of 5.14 ppm to 2.15-2.79 ppm. Only when the reaction was performed in a closed vessel under controlled atmosphere and elevated temperature could the selenate level be reduced to 0.31-0.32 ppm in 60 minutes, and to 0.12-0.14 ppm in 120 minutes. However, such controlled conditions are not economically feasible for treatment of low-value effluent streams. Without controlled conditions, the reaction time is long and/or the remaining selenate level is too high. It is desirable to remove much more selenate than reported.

As awareness of the environmental effects of selenium and heavy metals increases and the environmental regulations for removal of harmful compounds become stricter, the desire and need to remove such compounds more effectively and economically becomes greater. It is against this background that the present disclosure is made.

### SUMMARY

The present disclosure relates to systems and methods for removing selenium from an aqueous stream. In one exemplary embodiment, the method comprises adjusting the pH of the aqueous stream to an acidic pH and mixing a galvanic reductant into the aqueous stream to form a first process stream, the aqueous stream having a first selenium level; separating at least a majority of the galvanic reductant from the first process stream after a retention time to form a recovered galvanic reductant stream and a second process stream; adjusting pH of the second process stream to pH 9 or higher to form a third process stream comprising precipitated particles; separating the precipitated particles from the third process stream to form a sludge stream and a treated aqueous stream having a second selenium level, the second selenium level being less than 10% of the first selenium level. The galvanic reductant may be iron powder with a particle size of about 1 to about 75 μm. The galvanic reductant can be added at a concentration of about 10 to about 200 g/L by volume of the first process stream.

In one exemplary embodiment, the system includes at least one reactor, a separator, a precipitation reactor, and a clarifying system. The system may further include a series of reactors used for mixing and/or housing the first process stream, and one or more reactors used as the precipitation reactor. The separator may include a magnetic separator. The clarifying system may include gravitational systems, filters, or combinations thereof.

### BRIEF DESCRIPTION OF DRAWINGS

FIG. 1 is a schematic flow chart of a method for treatment of streams according to an embodiment.

FIG. 2 is a process flow chart of a method for treatment of streams according to exemplary embodiment of the method of FIG. 1.

FIG. 3 is a flow chart of a method for treatment of streams according to an embodiment.

FIG. 4 is a schematic cross sectional view of a magnetic drum separator used in the method of FIG. 3.

FIGS. 5A-5E are graphical presentations of data from Example 1.

FIGS. 6A-6G are graphical presentations of data from Example 2.

FIG. 7A is a schematic flow chart of a cementation and separation stage according to an alternative embodiment.

FIG. 7B is a schematic flow chart of a cementation and separation stage according to an alternative embodiment.

FIGS. 8A-8B are graphical presentations of data from Example 3.

### DETAILED DESCRIPTION

The present disclosure relates to systems and methods for removal of selenium, arsenic, and other contaminants from water. In particular, the present disclosure relates to systems and methods for removal of selenium, arsenic, and heavy metals from water with a high sulfate content.

The contaminants are generically referred to as the elements (e.g., selenium, arsenic, lead, cadmium, zinc, copper, chromium, iron, potassium, magnesium, manganese, nickel, antimony, etc.) here. However, the present method is applicable to various oxidation states of the elements, such as elemental selenium, selenides, selenites, and selenates; elemental arsenic, arsenites, and arsenates; etc.

The terms “remove” and “removal” are used here to refer to removing a constituent completely or in part. For example, “removal of selenium” is to be understood as lowering the level (concentration) of selenium in a substrate (e.g., in water).

The term “high sulfate content” is used here to refer to amounts of sulfate in excess of 0.5 g/L measured as sodium sulfate.

The term “about” is used here in conjunction with numeric values to include normal variations in measurements as expected by persons skilled in the art, and is understood have the same meaning as “approximately” and to cover a typical margin of error, such as ±5% of the stated value.

As used herein, “weight percent,” “wt-%,” “percent by weight,” “% by weight,” and variations of the same refer to the concentration of a substance as the weight of the substance relative to the total weight of the composition. The terms “percent” and “%” are intended to be synonymous with “weight percent” and “wt-%” unless specifically otherwise indicated.

The transitional phrase “consisting essentially of” as used in the claims limits the scope of the claim to the specified materials including only minor impurities or inactive agents that a person of ordinary skill in the relevant art would ordinarily associate with the listed components.

Effluent streams (e.g., wastewater or other aqueous outflow) from certain industrial processes may have a high sulfate content and are also contaminated with a number of other elements, whether in elemental or complexed forms. Examples of contaminants include various species of selenium, arsenic, lead, antimony, cadmium, chromium, and other heavy metals. In order to meet environmental regulations for water discharge, the contaminants must be removed from the water prior to discharge.

Removal of soluble selenium species selenite and selenate from high sulfate water is very difficult because the sulfate inhibits effective removal of the selenium species. In particular, existing methods for removal of selenium are not capable of satisfactorily removing selenate. Applicants have found that, for example, ferric iron co-precipitation, prior art iron cementation methods, and microbe-induced reduction methods are not able to effectively or economically remove selenate from high sulfate water.

The present systems and methods are capable of removing selenium, arsenic, lead, antimony, cadmium, and chromium from water, including water with high sulfate content. The systems and methods can be used to treat aqueous streams, such as effluent and wastewater streams from any industry where such removal is desired. The present systems and methods have been found to be particularly useful for removing selenate and heavy metals from wastewater from a lead battery recycling process. Additionally, the systems and methods can be used to treat aqueous streams from other industries, such as mining, oil refining, smelters, and power plants. For example, scrubber water from such industries often contains selenium, heavy metals, and sulfates. The systems and methods can also be used to treat contaminated ground water or water from surface water sources.

The present systems and methods use a combination of electrochemical reduction, galvanic reduction, cementation, and precipitation to remove contaminants. The systems and methods also allow for efficient recycling of the reducing agent (galvanic reductant) to maintain the removal process economically and ecologically efficient.

In some instances, it may be desirable to recover the contaminant from the aqueous stream. Enrichment of the galvanically reduced elements may render them amenable to economic recovery and enrichment and/or refinement.

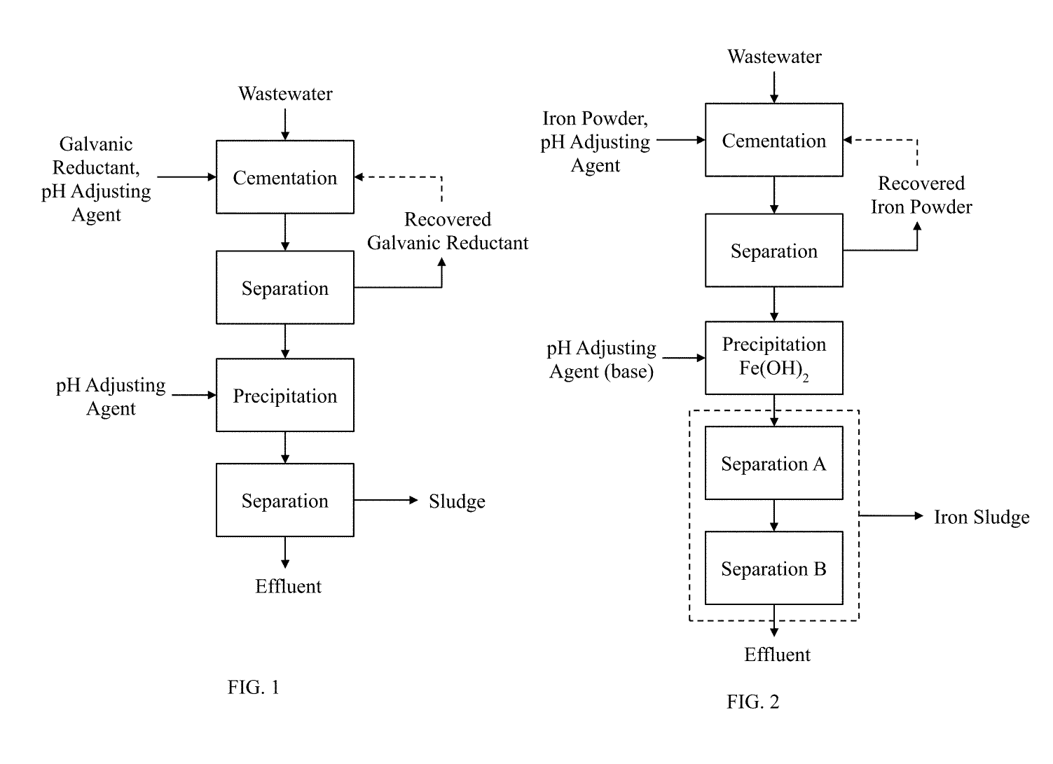

The principle of the present method is shown in the simplified flow diagram in FIG. 1. Although exemplary embodiments of treating wastewater are shown in the Figures, the method can also be used to treat other aqueous solutions and streams, such as process water or water from natural sources. The aqueous stream (e.g., a wastewater) is first mixed with a galvanic reductant and a pH adjusting agent in a cementation step. The pH of the cementation reaction can be about 1 to 5. After cementation, excess galvanic reductant can be separated and recovered, and can be returned back to the cementation step. The separated liquid portion is mixed with a second pH adjusting agent to adjust the pH up to about pH 8 to 10 in a precipitation step. The precipitated solids are again separated and removed as sludge from the effluent. The sludge may be disposed of, or contaminants may be recovered from the sludge.

The water may include process water or wastewater from various industrial processes or mining operations, or natural water that is in need of treatment. For example, the water may include process water from mining and extractive industries (e.g., copper, nickel, coal, oil and gas), smelters, power generation, land fill run-off, agricultural industries, etc. In some examples, the water includes selenium at a concentration above current EPA standards, e.g., above 0.05 (EPA drinking water standard), above 1 ppm, above 5 ppm, above 10 ppm, above 50 ppm, or above 100 ppm. The water may include about 1 to 1000 ppm selenium. The water may also be contaminated with various other contaminants, including lead, cadmium, zinc, copper, chromium, iron, potassium, magnesium, manganese, nickel, antimony, arsenic, or any combination thereof. The impurities may be present at high levels, including up to about 1000 ppm each. The water may also include high levels of sulfate, e.g., about 0.5 to about 500 g/L sodium sulfate, or about 20 to about 200 g/L.

Iron cementation is typically performed at a pH slightly below 7, such as about pH 5 to 6. However, it has been found that selenate removal can be improved at a lower pH. On the other hand, a very low pH increases losses of the galvanic reductant (e.g., iron) due to acid dissolution. In order to be able to run the process in an economically feasible manner, the losses of galvanic reductant should be minimized and any unused galvanic reductant recycled. Because acid dissolution increases galvanic reductant losses, using a higher pH can help minimize losses. However, a higher pH can make selenium removal less efficient. According to an embodiment, the pH of the cementation stage ranges from about 1 to about 5, about 1.5 to about 4, about 2.2 to about 3.8, about 2 to about 3.5, or about 2 to about 3. Depending on the pH of the incoming water stream, the pH of the cementation stage can be adjusted up with a base or down with an acid to maintain the pH within the desired range. Most commonly pH of the cementation stage needs to be adjusted down with an acid. Any suitable acid or base can be used, including mineral acids such as sulfuric, hydrochloric, phosphoric, or nitric acid, carbonic acid, and organic acids, such as ethanoic (acetic), sulfonic, or citric acid, or combinations thereof. Suitable bases include sodium hydroxide, sodium carbonate, ammonium carbonate, calcium oxide, potassium oxide, etc. In water that is high in sodium sulfate, pH adjustments can most conveniently be done using sodium hydroxide and sulfuric acid. In one embodiment, pH of the cementation stage is adjusted down to about pH 2 to 4 using sulfuric acid.

According to an aspect of the present method, the particle size of the galvanic reductant is controlled to control the reaction rate of the cementation stage and also to control losses and recovery of the galvanic reductant. The particle size of the galvanic reductant is preferably less than 100 μm, or in the range of about 1 to about 75 μm, or less than about 50 μm, less than about 25 μm, or less than about 10 μm. In some embodiments the particle size of the galvanic reductant is about 2 to about 10 μm, about 3 to about 7 μm, or about 4 to about 6 μm.

Losses due to acid dissolution may also be reduced by using a corrosion inhibitor. Examples of corrosion inhibitors include anodic inhibitors and organic inhibitors. Anodic inhibitors are also known as passivators due to their action of passivating the surface of metal by creating a protective layer of oxide film on the surface of the metal. Exemplary anodic corrosion inhibitors include chromates, molybdates, nitrites, and orthophosphates. Organic inhibitors typically act by forming a protective film on metal, acting as a barrier to dissolution. Exemplary organic corrosion inhibitors include amines, urea, mercaptobenzothiazole, benzotriazole, aldehydes, heterocyclic nitrogen compounds, sulfur-containing compounds, and acetylenic compounds. Corrosion inhibitors can be added at the cementation stage at a suitable concentration to manage dissolution losses.

The amount of galvanic reductant added to the cementation stage can be about 5 to about 250 g galvanic reductant per liter of aqueous (e.g., wastewater) solution, or about 10 to about 200 g/L, about 50 to about 175 g/L, or about 75 to about 150 g/L about 90 to about 110 g/L. The galvanic reductant can be added continuously or intermittently. For example, an initial amount of galvanic reductant can be added to result in a desired concentration (e.g., about 80 to about 120 g/L). When the process is run, the galvanic reductant can be recovered and recycled back into the front of the process, adding only an amount of galvanic reductant sufficient to maintain the desired concentration. For example, it may be necessary to only add about 1 to about 10 g/L galvanic reductant once the process has reached a steady state.

Any suitable galvanic reductant can be used in the cementation stage that is able to provide an electromotive potential for the reaction to occur, such as iron, aluminum, zinc, cadmium, nickel, lead, antimony, copper, or arsenic. However, when iron is used as the galvanic reductant it can be effectively and efficiently removed using a magnetic separator after the cementation stage.

In an exemplary embodiment the galvanic reductant is iron powder that is used to remove selenium (both selenate and selenite) from the water. The reactions between the iron galvanic reductant and selenium may include the following:

HSeO₄⁻_{(aq)}+3H⁺+Fe=H₂SeO_{3(aq)}+H₂O+Fe²⁺

SeO₄²⁻_{(aq)}+4H++Fe=H₂SeO_{3(aq)}+H₂O+Fe²⁺

SeO₄²⁻_{(aq)}+3H⁺+Fe=HSeO₃⁻_{(aq)}+H₂O+Fe²⁺

H₂SeO_{3(aq)}+4H⁺+2Fe=Se+3H₂O+2Fe²⁺

H₂SeO_{3(aq)}+4H⁺+2Fe=Se+3H₂O+2Fe²⁺

FIG. 2 shows a simplified process flow diagram of an exemplary embodiment where the galvanic reductant is iron powder. The recovered iron powder can be returned from the first separation step into the cementation step and reused. The cementation reactions cause the formation of reduced metal species, some reduced to elemental states, and iron(II) ions (Fe′) in the reaction mixture. The second pH adjusting agent (a base) raises the pH of the reaction mixture and causes the precipitation of iron (II) hydroxide. The iron (II) hydroxide precipitate and the contaminants can be separated from the mixture, resulting in a treated effluent.

The cementation mixture is maintained at the lowered pH (e.g., pH from about 2 to about 4.5) for a suitable retention time to allow for the cementation reactions to occur. The cementation stage may be conducted in a single reactor, e.g., the first reactor 10. For example, the retention time of cementation stage in the first reactor 10 can vary from about 30 minutes to about 2 hours, or from about 40 minutes to 90 minutes.

In one embodiment, the cementation stage is performed in a series of reactors, such as two, three, four, or five consecutive reactors. The retention time in the subsequent reactors can be similar to the retention time in the first reactor, or can be longer or shorter. In an exemplary embodiment, the method is a continuous process and the average retention time of the mixture in the reactors is about 5 to about 30 minutes, or about 10 to about 20 minutes. The retention time of the cementation stage is the total time the mixture spends in (e.g., flowing through) the series of reactors. For example, the retention time (the total time in the cementation stage) may be from about 40 to about 240 minutes, from about 45 to about 180 minutes, from about 50 to about 120 minutes, from about 55 to about 90 minutes, or from about 60 to about 75 minutes.

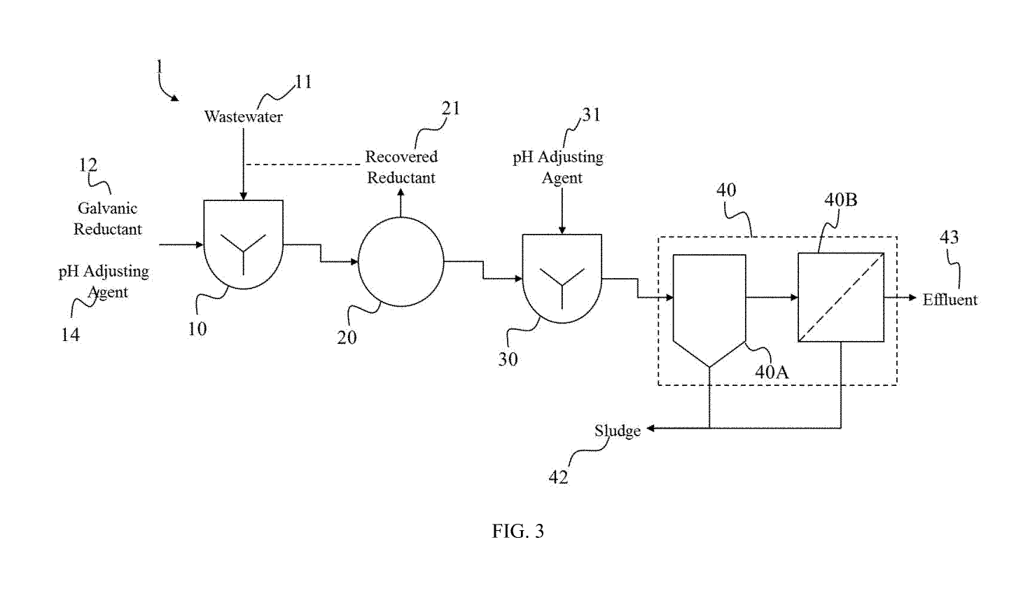

The method can be carried out in any suitable system. One such suitable system comprises at least a first reactor 10, a separator 20, a precipitation reactor 30, and a clarifying system 40. A simplified flow diagram of an exemplary system 1 and the method is shown in FIG. 3. Water 11 is charged into a first reactor 10 and mixed with a galvanic reductant 12. The pH of the mixture is adjusted to and/or maintained at about pH 1 to 5 using a first pH adjusting agent 14. After a suitable retention time in the first reactor 10, the mixture is transferred into a separator 20 to recover any unused galvanic reductant 12. In some embodiments where the galvanic reductant 12 includes iron, the separator 20 may be a magnetic separator. The separated galvanic reductant (e.g., iron particles) can be returned to the first reactor 10.

The separated liquid portion from the separator 20 is directed to a precipitation reactor 30, where the pH of the liquid is adjusted up to about pH 8 to 10 with a second pH adjusting agent 31. Precipitated materials (e.g., precipitated iron hydroxide and impurities such as selenium, lead, arsenic, antimony, cadmium, copper, chromium, etc.) are removed in a clarifying system 40 and are removed from the stream as sludge 42. The clarifying system 40 can be a multi-part system and can include, for example, a gravitational clarifier 40A and a filter 40B. Effluent 43 (treated aqueous stream) from the clarifying system 40 can be discharged, or further treated or reused as desired.

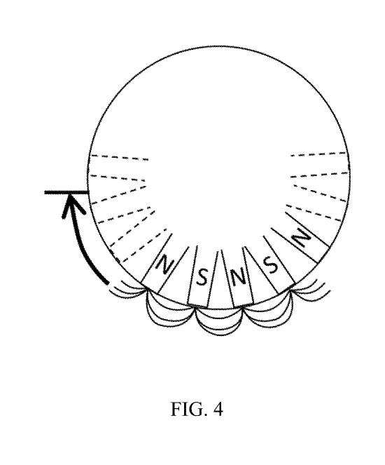

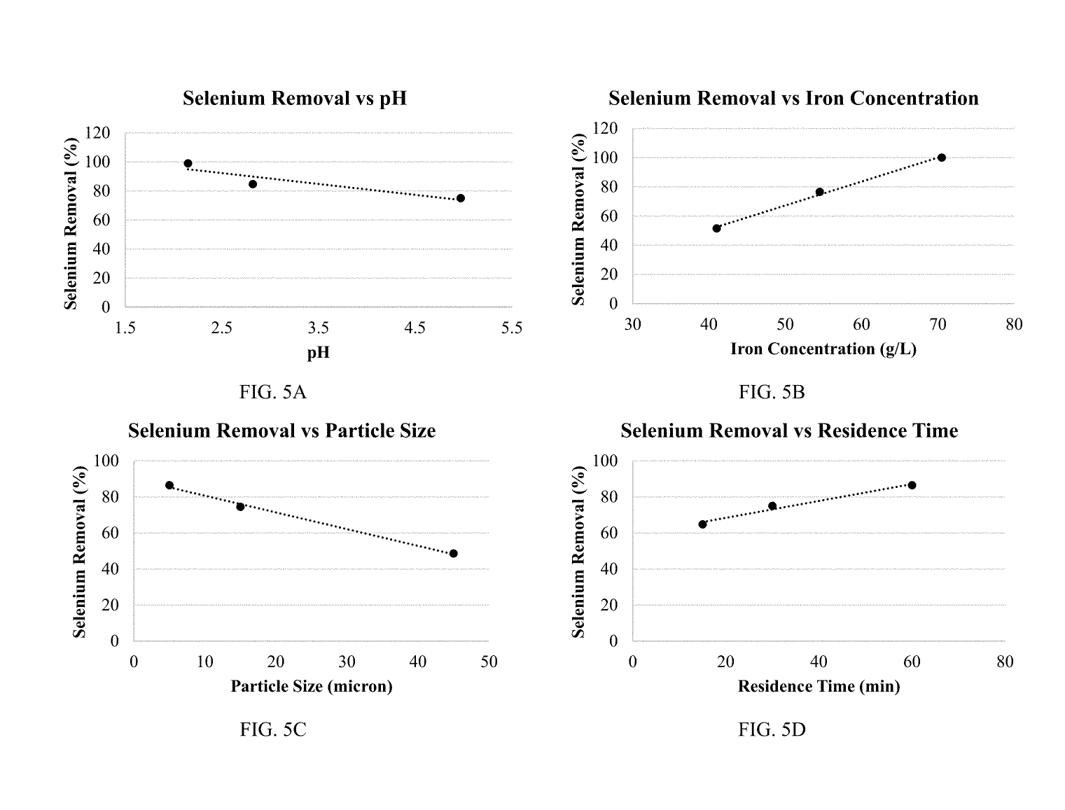

In some embodiments where the galvanic reductant includes iron, the separator may be a magnetic separator, such as a magnetic drum separator. The mixture is applied to the outside of a rotating drum, and magnets inside the drum attract and separate iron particles from the mixture. A schematic cross sectional view of a magnetic drum separator is shown in FIG. 4. As the drum rotates in the direction of the arrow, iron particles are removed from the flow of the mixture and can be scraped off the surface of the drum.

The recovered galvanic reductant is preferably returned to the cementation stage. In some embodiments, the recycling rate of the galvanic reductant can be over 90%, or over 95%. Some iron is inevitably lost in the cementation reaction. For example, about 2 to about 15 g/L of galvanic reductant may be used in the cementation reaction (e.g., chemical losses). However, if other losses, such as acid dissolution, are minimized, and an effective recovery system is used, the recycling rate can be very high. For example, when the galvanic reductant is iron, and the particle size of the iron and the pH of the cementation reaction are selected as discussed above, and the iron is separated using a magnetic reparatory, the recycling rate of the iron can be up to 96 to 99%, or in some instances even higher than 99%.

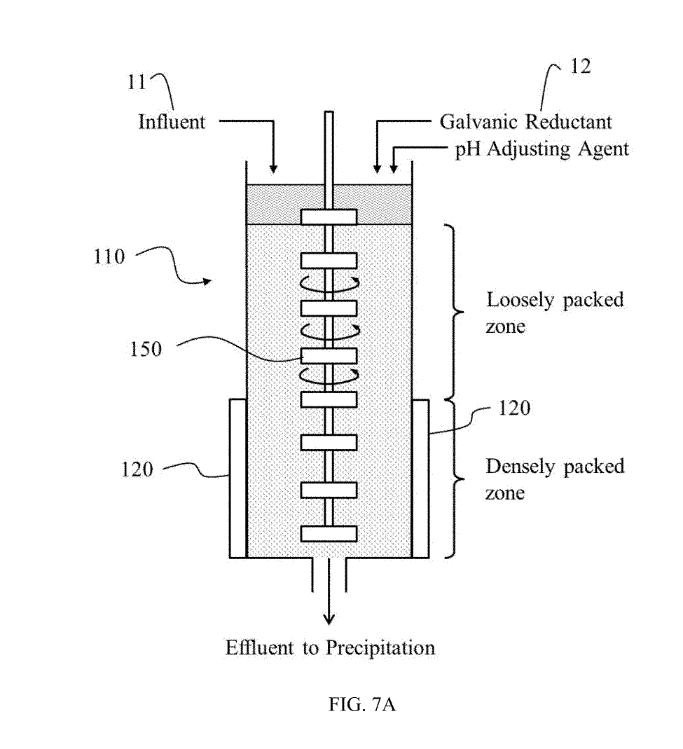

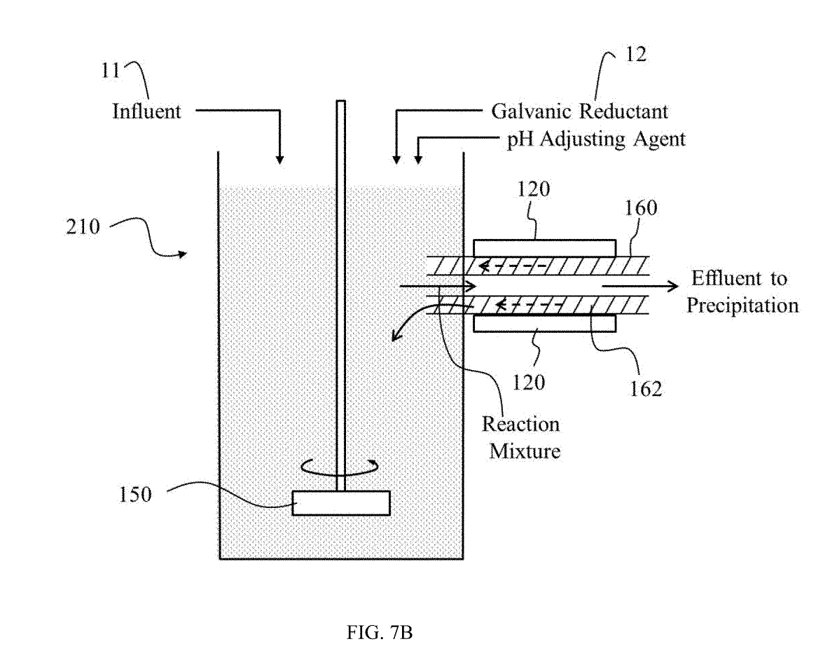

In some embodiments the first reactor and separator are combined into a single reactor, such as the exemplary reaction and separation vessels 110, 210 shown in FIGS. 7A and 7B.

In FIG. 7A, the reaction and separation vessel 110 is a packed column type vessel, where influent 11, galvanic reductant 12, and pH adjusting agent 14 are input into the vessel, and the mixture is slowly agitated with an agitator 150. The column can include a loosely packed zone in an upper area of the column, and a more densely packed zone at the bottom of the column. The galvanic reductant (e.g., iron particles) can be retained in the column by magnets 120 positioned along the walls of the column, while the separated liquid portion is flown out through an outlet for further treatment. The size, shape, and orientation of the vessel can be adjusted and is not limited to those shown in the figure.

In the other exemplary embodiment shown in FIG. 7B, the reaction and separation vessel 210 includes a cross-flow type system. Influent 11, galvanic reductant 12, and pH adjusting agent 14 are input into the vessel, and the mixture is mixed with an agitator 150. The reaction mixture flows out into an outlet pipe 160 that includes an auger 162 and magnets 120 positioned along the walls of the outlet pipe 160. The auger 162 can be positioned in the outlet pipe 150 such that the auger blade follows the walls of the pipe, leaving a hollow center flow path. The auger 162 can be arranged to have a direction of flow that is opposite of the direction of flow of the process mixture. The magnets 120 retain the galvanic reductant (e.g., iron particles), and the auger 162 is operated to return the retained galvanic reductant back into the reaction and separation vessel 210, while the separated liquid portion flows out through an outlet for further treatment.

After removal of any unreacted galvanic reductant, the liquid from the separator 20, 110, 210 is directed to a precipitation reactor 30 or a series of precipitation reactors. To induce precipitation of dissolved species of selenium, galvanic reductant, and other impurities, the pH of the liquid is adjusted up to about pH 8 to 10. The pH can be adjusted to maximize the removal of impurities. For example, the pH can be adjusted to about 8 or higher, about 8.2 or higher, or about 8.4 or higher, and about 9.8 or lower, about 9.6 or lower, or about 9.4 or lower. In one embodiment, the pH is adjusted to about pH 8 to 9.5. At the elevated pH, metals and other impurities that form insoluble hydroxides (e.g., iron hydroxide, lead hydroxide) precipitate and fall out of solution. Soluble metal species may also be removed through adsorption onto the precipitated solid particles. Impurities that can be removed in addition to selenium and dissolved galvanic reductant (e.g., iron) include, for example, cadmium, lead, antimony, arsenic, zinc, nickel, copper, etc.

The precipitate is separated from the process stream in a clarifying system 40 and removed from the stream as sludge 42. Any suitable separators can be used and combined to effect the desired level of separation. For example, the clarifying system 40 can include gravitational systems (e.g., gravity separation tanks, tables, centrifuges, etc.), filters, or combinations thereof. The water stream treated using the present system and method can be further purified, or can be discharged. For example, depending on environmental permitting and removal of other contaminants (e.g., sulfate), the effluent water stream can be discharged into a body of water.

The method may also include an optional oxidation step to increase the oxidation reduction potential (“ORP”) of the aqueous solution. The oxidation step may be performed in any suitable manner, such as by addition of a peroxide compound (e.g., hydrogen peroxide), by aeration, etc. In one example, the oxidation step includes adding a peroxide compound or aerating the aqueous liquid after the cementation to increase ORP to turn ferrous iron to ferric iron, in order to enable iron hydroxide precipitation at lower pH values. The aqueous stream may also be oxidated at the end of the process, prior to discharge.

In one embodiment, various elements can be recovered from the process stream after the cementation stage and prior to the precipitation stage. The process stream from the separator (e.g., magnetic separator) contains both elemental (zero valent) and aqueous states of many elements from the galvanic reduction process. The process stream may be directed to an additional separation step, where elemental and aqueous states are separated using filtration, centrifuging, gravity separation, or the like. According to an aspect, concentration of the various elements produces a recovery sludge stream, which can be further enriched and/or refined in an enrichment step. The enrichment step results in a refined/enriched element stream and an impurities/waste stream. The impurities/waste stream may be further separated and enriched to refine other highly concentrated elements in the stream. The final waste streams from the additional separation step, whether solid or aqueous, can be returned to and combined with the main process stream. Depending on the physical and chemical characteristics of the waste stream from the enrichment step, the waste stream can be reprocessed again starting at the cementation stage, or can be injected into the process stream just before the precipitation stage. In one exemplary embodiment, selenium is recovered and refined in an enrichment step.

Any of the process stages (e.g., cementation, separation, precipitation, etc.) and embodiments (e.g., combined cementation and separation, additional separation, etc.) described here can be performed in multiple sequential vessels. Further, various embodiments can be combined with each other as desired.

According to at least some embodiments, the effluent water stream includes less than 3 ppm, less than 1 ppm, less than 0.3 ppm, less than 0.25 ppm, less than 0.2 ppm, less than 0.15 ppm, less than 0.1 ppm, less than 0.08 ppm, less than 0.06 ppm, or less than 0.05 ppm selenium. The method may be more than 95% effective, more than 96% effective, or more than 97% effective at removing selenium from wastewater. In some aspects, the method is about 97 to about 99% effective at removing selenium from wastewater.

The method may also be highly effective at removing other contaminants, such as lead, cadmium, zinc, copper, chromium, iron, potassium, magnesium, manganese, nickel, antimony, and arsenic. The effluent water stream may also include a total of less than 200 ppm, less than 150 ppm, less than 100 ppm, less than 50 ppm, less than 20 ppm, less than 15 ppm, less than 10 ppm, or less than 5 ppm of other impurities that were initially present in the wastewater stream, such as lead, cadmium, zinc, copper, chromium, iron, potassium, magnesium, manganese, nickel, antimony, and arsenic. For example, the effluent water stream may include less than about 0.5 ppm, less than 0.2 ppm, or less than 0.1 ppm cadmium; less than about 0.5 ppm, less than 0.2 ppm, or less than 0.1 ppm lead; less than about 1 ppm, less than about 0.5 ppm, or less than 0.2 ppm antimony; and less than about 1 ppm, less than about 0.5 ppm, or less than 0.2 ppm arsenic. The method may be about 96% to about 100% effective at removing lead, antimony, and arsenic, and about 85% to 95% effective at removing cadmium.

### EXAMPLES

### Example 1

The effect of various parameters on selenium removal was tested in a pilot scale system using 8 h test runs. The system included three reactors in the cementation stage, a magnetic separator for removing iron, and two reactors in the precipitation stage. The galvanic reductant was iron powder; the acid used to adjust pH was sulfuric acid; and the base was sodium hydroxide. Selenium removal as a function of pH in the cementation stage, iron concentration, iron powder particle size, and residence time were tested.

Initial selenium concentration in the wastewater sample varied between about 3-15 ppm. The wastewater also included about 100 g/L sulfate. The wastewater sample was introduced into the first cementation stage reactor and was mixed with sulfuric acid and iron powder.

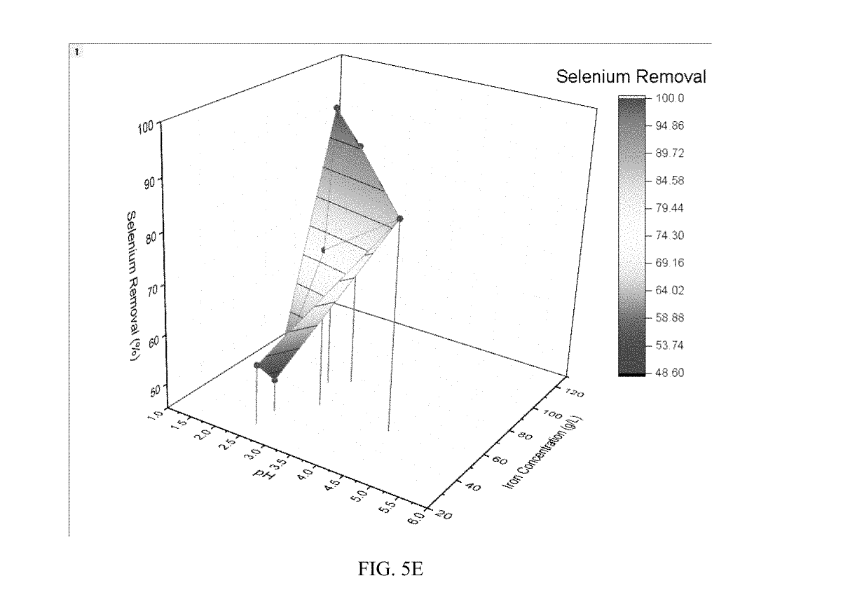

The removal of selenium as a function of pH, iron concentration, iron particle size, and residence time in the reactor were evaluated. The results are shown in FIGS. 5A-5D. FIG. 5E is a 3D-graphic of selenium removal as a function of pH and iron concentration. The iron particle size was held at 5 μm and the residence time at 60 minutes during the pH and iron concentration tests.

It was observed that lower pH and increase in iron concentration improved selenium removal, with pH of 2.5-3.0 and iron concentration of 70-80 g/L resulting in almost 100% removal. A decrease in the iron powder particle size and a longer residence time also improved selenium removal.

### Example 2

A pilot scale experiment to remove contaminants from wastewater was run over the course of five days according to an embodiment of the present disclosure. While the system was run continuously, removal of impurities was evaluated every four hours (six times per day). The incoming wastewater included various levels of arsenic, cadmium, chromium, copper, iron, lead, antimony, selenium, and zinc. The wastewater also included about 100-150 g/L sulfate over the course of the pilot run.

The pilot scale system included a series of five reactors, 55 gallons each. First three reactors were used for the cementation reaction, and the fourth and fifth reactors for iron precipitation. Residence time in each reactor was adjusted so that the total residence time was about 1 hr, resulting in a flow rate of about 1 gal/min. The reaction was run at ambient temperature and was not temperature controlled. However, the incoming wastewater stream had a temperature of about 100° F.

Wastewater was fed into reactor 1 at a flow rate of about 1 gal/min. Iron particles were initially loaded into reactors 1, 2, and 3 at about 90-110 g/L. After the initial loading, additional iron was continuously fed into reactor 1 as needed to maintain a constant iron concentration. The iron particles had an average particle size of about 15 μm. Reactors 1, 2, and 3 were continuously mixed to maintain the iron particles in suspension.

The cementation stage (reactors 1, 2, and 3) had a pH of 3-3.5, adjusted by the addition of sulfuric acid. The pH of the precipitation stage was pH 7.5-8.5 in reactor 4, and pH 8.5-9.5 in reactor 5, adjusted by the addition of sodium hydroxide.

Samples of incoming wastewater and the treated water were taken every four hours and analyzed using ICP-OES (inductively coupled plasma optical emission spectrometry) to test for the amount of arsenic, cadmium, chromium, copper, iron, lead, antimony, selenium, and zinc. The process was kept running and samples were taken even during process upsets. As can be seen in the resulting data, three process upsets occurred during the pilot run. At sample points 6, 15, and 21, the iron feeder stopped working. At sample points 13-15, the acid reservoir ran empty causing an increase in the pH of reactors 1 and 2.

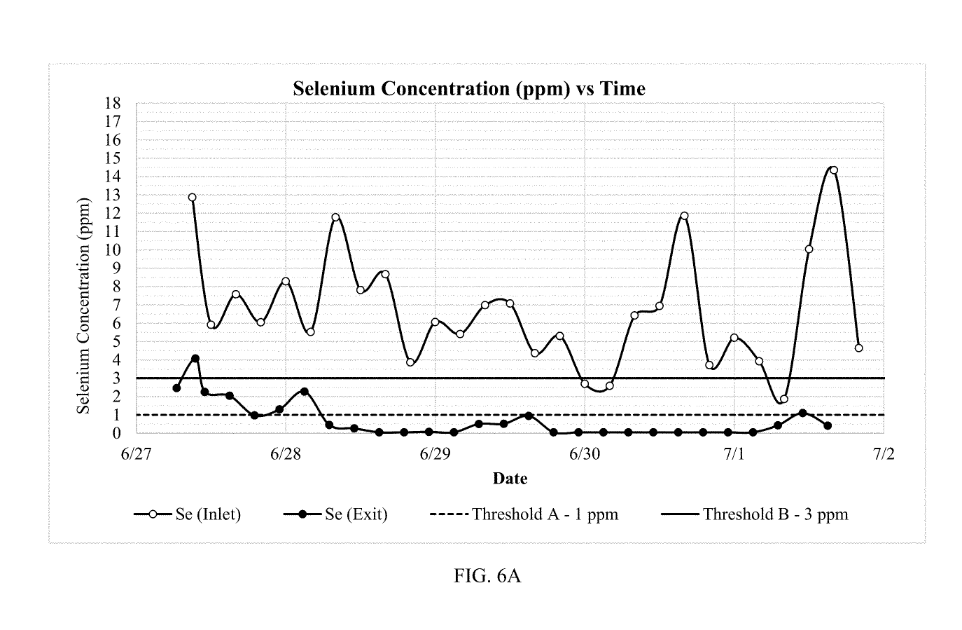

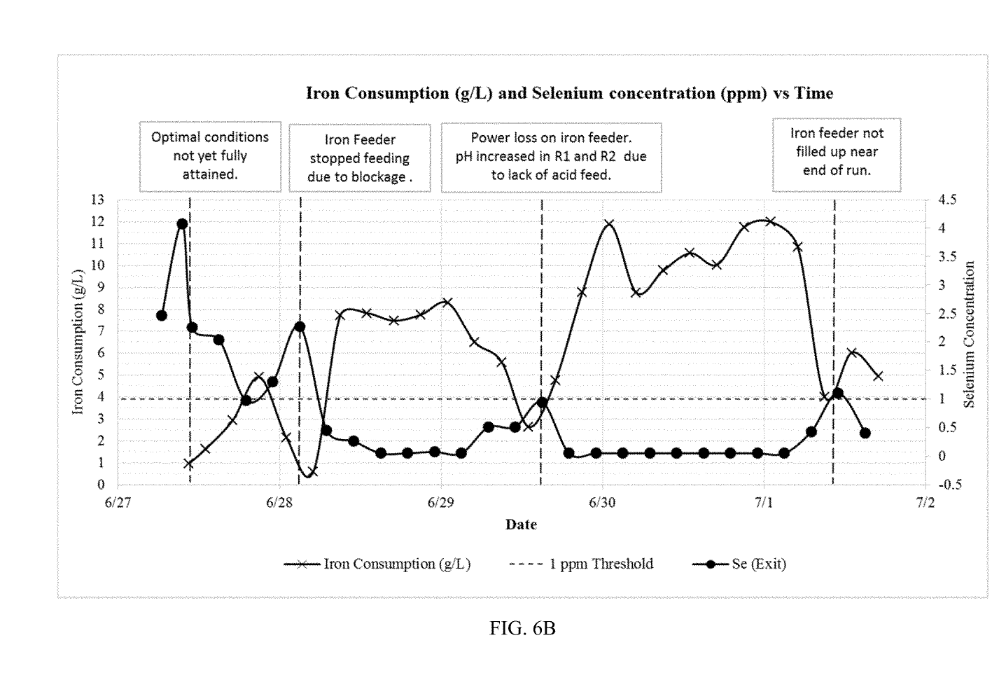

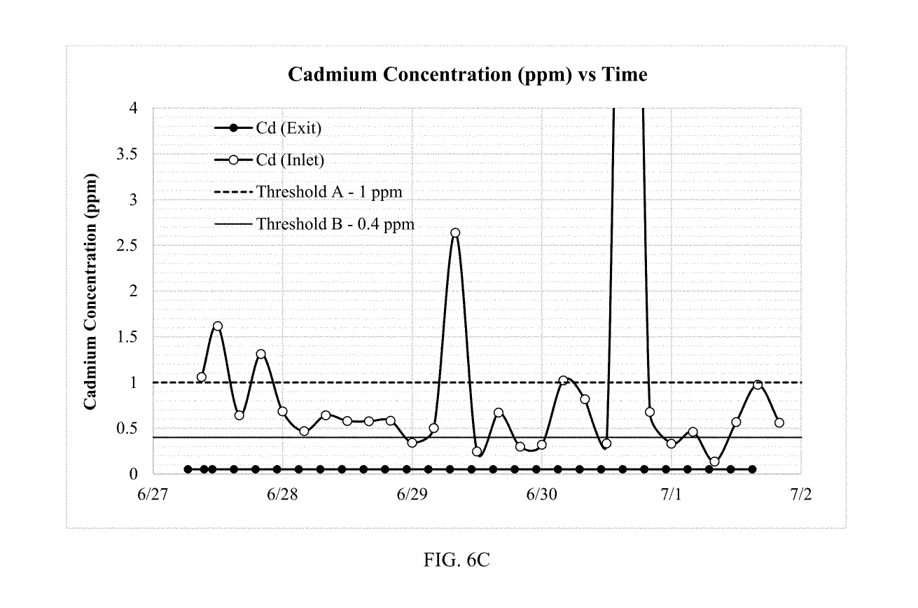

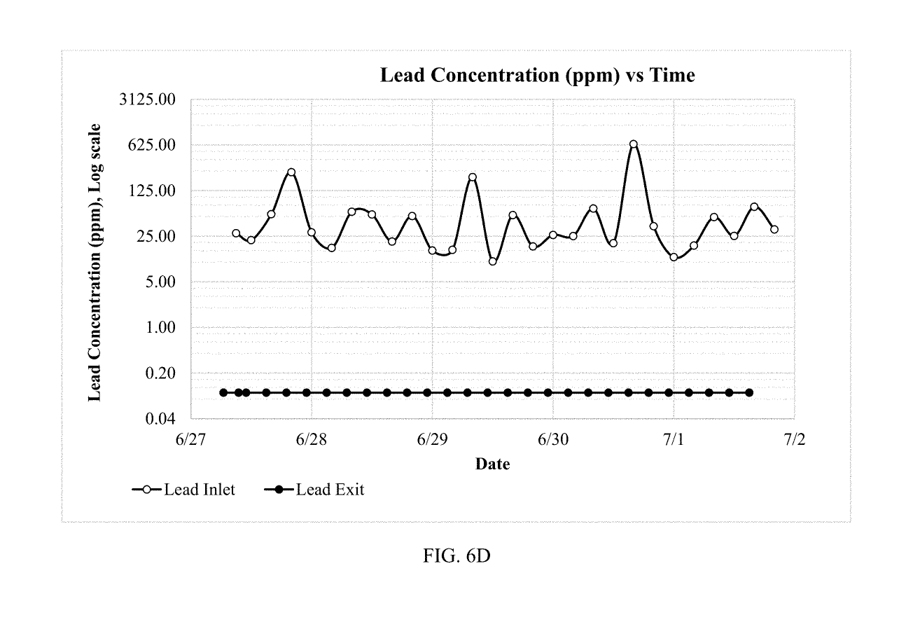

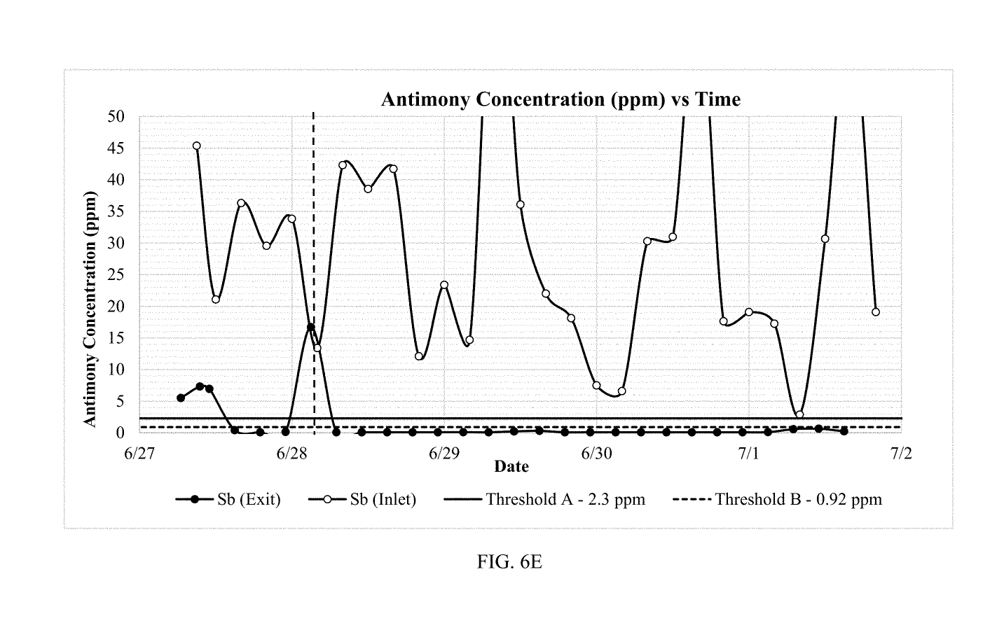

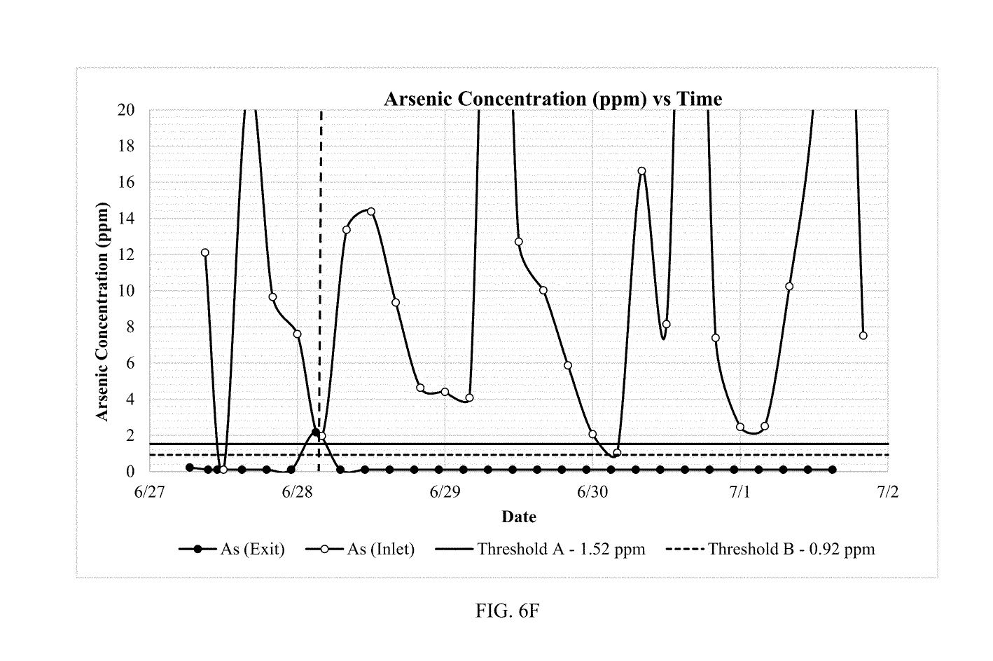

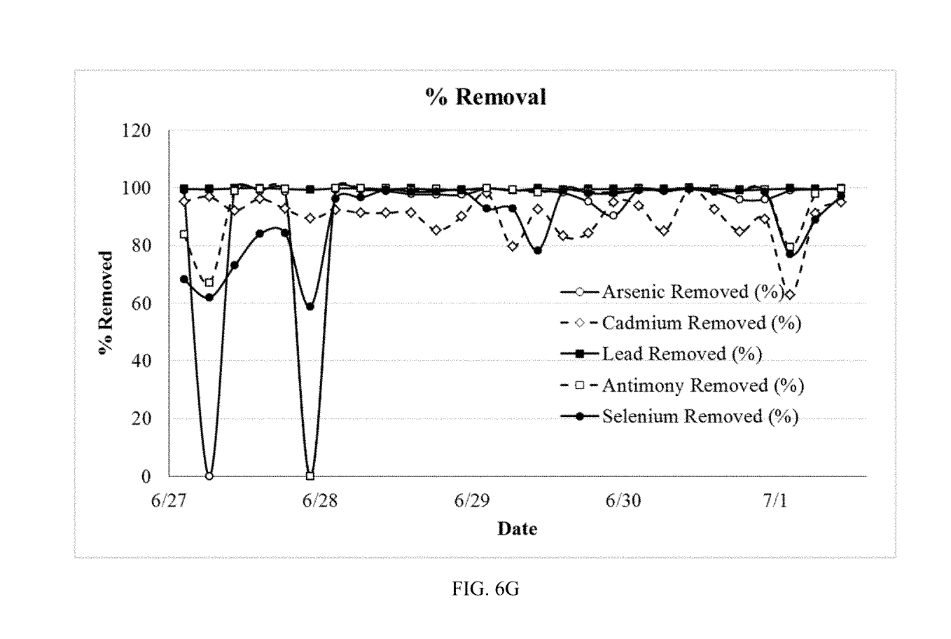

The results are shown in FIGS. 6A-6G. Selenium concentration at the inlet and at the exit is shown in FIG. 6A. FIG. 6B shows the iron consumption in g/L (calculated value) and the selenium concentration at the exit during the trial. The process upsets are noted with dotted vertical lines in FIG. 6B and are annotated at the top of the graph to indicate reasons for each variation in process conditions. The same reasons apply to the other graphs (FIGS. 6A and 6C-6G). Cadmium concentration is shown in FIG. 6C, lead concentration in FIG. 6D, antimony in FIG. 6E, and arsenic in FIG. 6F. The %-removal of arsenic, cadmium, lead, antimony, and selenium is shown in FIG. 6G.

Because threshold values of various compounds in wastewater discharge vary by location (e.g., by state or by city), the different compounds were evaluated against two different threshold values, threshold A and threshold B.

It was observed that during steady process conditions (iron concentration at about 90-110 g/L and pH about 3-3.5), the removal of selenium, arsenic, lead, and antimony were nearly at 100%. Cadmium was removed at about 83-90% efficiency. During optimal operating conditions (when selenium was measured at below 0.5 ppm at the exit), iron was consumed at about 7.5-12 g/L. When the system did not have enough iron and the iron consumption fell below about 7 g/L, selenium was not removed as effectively. However, only when iron consumption fell below 5 g/L, did selenium at the exit exceed the threshold limit of 1 ppm. It was also observed that changes in the amount of iron and the pH of the cementation stage caused a negative impact on the removal of impurities.

The removal of zinc, copper, and chromium was also measured. The levels of zinc, copper, and chromium in the incoming wastewater were very low (below 0.41 mg/L, 0.78 mg/L, and 0.86 mg/L, respectively). The remaining level of each of the components at the exit was below the detection level of the ICP-OES instrument.

### Example 3

A second pilot scale experiment was run to study the effect of process parameters on the removal efficiency of contaminants from wastewater according to an embodiment of the present disclosure. The incoming wastewater included various levels of arsenic, cadmium, chromium, copper, iron, lead, antimony, selenium, and zinc. The wastewater also included about 100-150 g/L sulfate over the course of the pilot run.

The pilot scale system was similar to the system used in Example 2, with the exception that the system included a rotary magnetic separator. Wastewater was fed into reactor 1 at a flow rate of about 1 gal/min (about 4 liters/min). Iron particle concentration ranged from at about 70-145 g/L, and averaged about 109 g/L. pH in the cementation ranged from 4.37 to 4.99, and in the precipitation stage from 9.17 to 9.42.

The recovery and consumption of iron particles, and the concentration of iron and its impact on selenium removal are shown in TABLE 1. Data points from five separate dates and one date rage of the pilot trial were selected to demonstrate variation in the selenium removal.

TABLE 1
Iron Recovery and Consumption, Selenium Removal

| | | Iron | | | | |
|---|---|---|---|---|---|---|
| | | Concen- | Residence | Iron | Iron | Selenium |
| | | tration | Time | Recovered | Consumed | Removed |
| Day | pH | (g/L) | (min) | (%) | (g/L) | (%) |
| 1 | 5.0 | 89 | 26 | 99.4 | 4.1 | 79 |
| 2 | 4.5 | 258 | 25 | 99.4 | 5.4 | 77 |
| 7 | 4.4 | 207 | 25 | 99.3 | 10.0 | 98 |
| 8 | 5.0 | 260 | 39 | 99.4 | 8.3 | 83 |
| 18 | 4.8 | 121 | 29 | 99.3 | 4.1 | 67 |
| 20-24 | 4.9 | 109 | 29 | N/A | 2.6 | 67 |

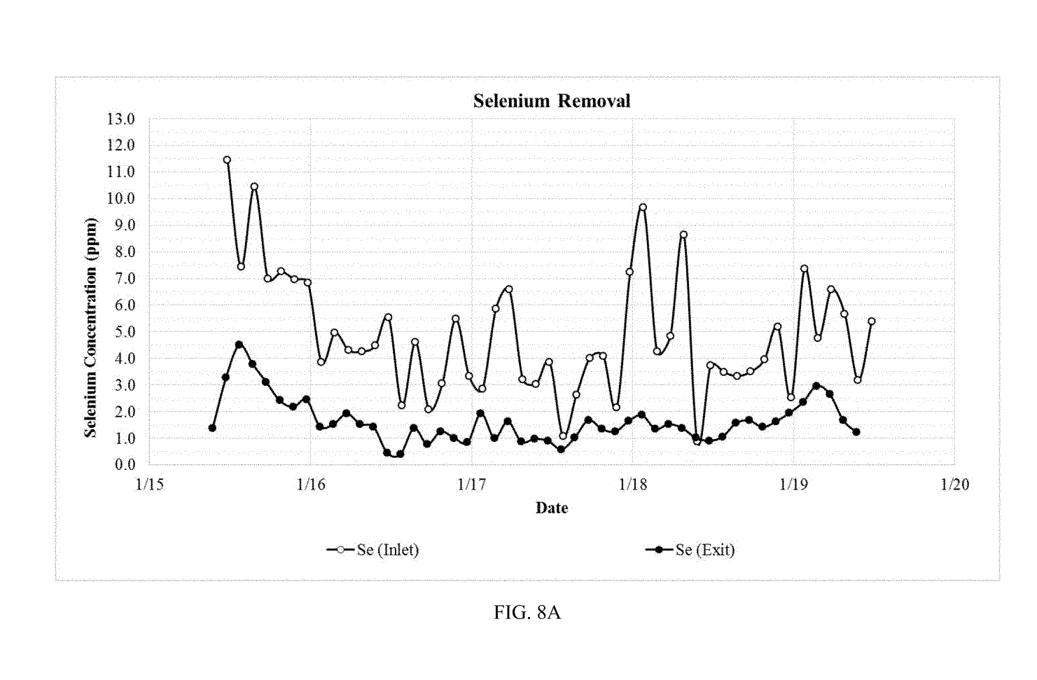

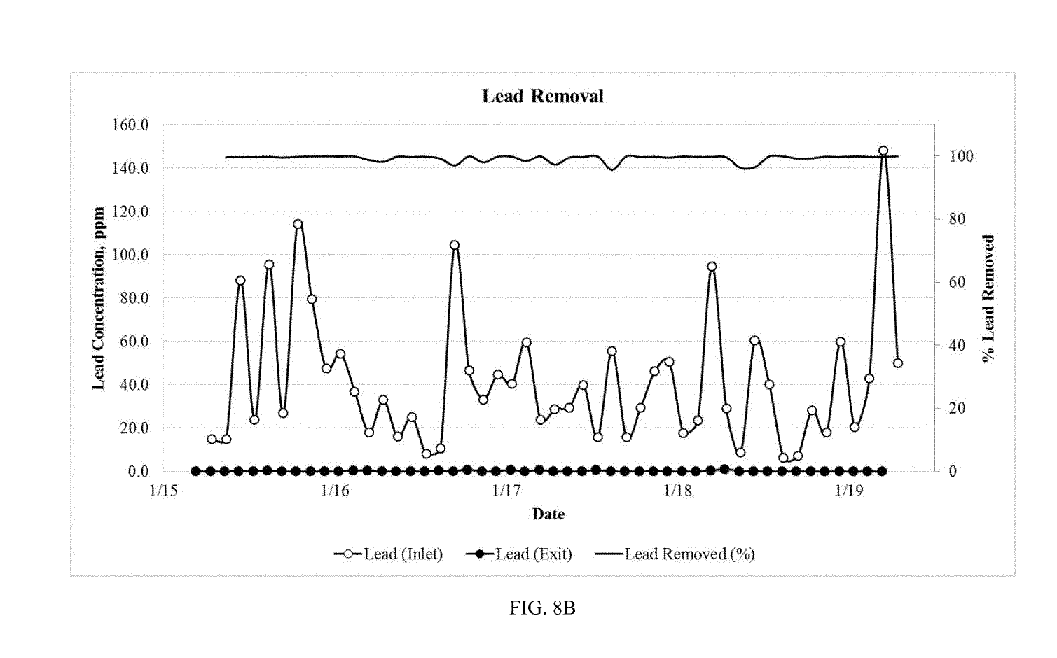

Results of the pilot trial showing selenium concentration and lead concentration are shown in FIGS. 8A and 8B, respectively.

It was observed that iron particles could be recovered and recycled in the process very efficiently using the magnetic separator. It was concluded that the process conditions could be varied to balance iron recovery and selenium removal. It was observed that the iron concentration had a lesser impact on removal of other contaminants, such as lead.

While certain embodiments of the invention have been described, other embodiments may exist. While the specification includes a detailed description, the invention's scope is indicated by the following claims. The specific features and acts described above are disclosed as illustrative aspects and embodiments of the invention. Various other aspects, embodiments, modifications, and equivalents thereof which, after reading the description herein, may suggest themselves to one of ordinary skill in the art without departing from the spirit of the present invention or the scope of the claimed subject matter.

What is claimed is:

1. A method for removing selenium from an aqueous stream, the method comprising:
adjusting pH of the aqueous stream to an acidic pH and mixing a galvanic reductant into the aqueous stream to form a first process stream, the aqueous stream having a first selenium level;
separating at least a majority of the galvanic reductant from the first process stream after a retention time to form a recovered galvanic reductant stream and a second process stream;
adjusting pH of the second process stream to about pH 9 or higher to form a third process stream comprising precipitated particles; and
separating the precipitated particles from the third process stream to form a sludge stream and a treated aqueous stream having a second selenium level, the second selenium level being less than about 10% of the first selenium level.

2. The method of claim 1, wherein the galvanic reductant is an iron powder.

3. The method of claim 1, wherein the galvanic reductant has a particle size of about 1 to about 75 μm.

4. The method of claim 1, wherein the galvanic reductant has a particle size of about 1 to about 50 μm.

5. The method of claim 1, wherein the galvanic reductant has a particle size of about 2 to about 10 μm.

6. The method of claim 1, wherein the galvanic reductant is added at a concentration of about 50 to about 150 g/L by volume of the first process stream.

7. The method of claim 1, wherein the galvanic reductant is added at a concentration of about 75 to about 120 g/L by volume of the first process stream.

8. The method of claim 1, wherein separating the at least a majority of the galvanic reductant comprises using magnetic separation.

9. The method of claim 1, wherein the pH of the aqueous stream is adjusted to about pH 2 to about pH 4.

10. The method of claim 1, wherein the pH of the aqueous stream is adjusted to about pH 3 to about pH 3.5.

11. The method of claim 1, further comprising maintaining pH of the first process stream at about 2 to about 4 for about 40 to about 120 minutes.

12. The method of claim 1, further comprising maintaining pH of the first process stream at about 2 to about 4 for about 40 to about 90 minutes.

13. The method of claim 1, further comprising maintaining pH of the first process stream at about 2.2 to about 3.8 for about 40 to about 75 minutes.

14. The method of claim 1, wherein the pH of the aqueous stream is adjusted with sulfuric acid.

15. The method of claim 1, wherein the pH of the second process stream is adjusted with sodium hydroxide.

16. The method of claim 1, wherein the second selenium level is about 3 ppm or lower.

17. The method of claim 1, wherein the second selenium level is about 1 ppm or lower.

18. The method of claim 1, further comprising separating and enriching selenium from the second process stream before adjusting the pH of the second process stream to about pH 9.

19. The method of claim 1, further comprising returning the recovered galvanic reductant stream into the first process stream.

20. A method for treating an aqueous stream, the method comprising:
adjusting pH of the aqueous stream to a pH of about 2 to about 4;
mixing about 75 to about 120 g/L of a galvanic reductant having a particle size of about 1 to about 50 μm into the aqueous stream to form a first process stream;
maintaining pH of the first process stream at about 2 to about 4 for a retention time of about 40 to about 90 minutes;
separating at least a majority of the galvanic reductant from the first process stream after the retention time to form a recovered galvanic reductant stream and a second process stream;
adjusting pH of the second process stream to about pH 9 or higher to form a third process stream comprising precipitated particles; and
separating the precipitated particles from the process stream to form a sludge stream and a treated aqueous stream.
